(19) United States
(12) Patent Application Publication
(10) Pub. No.: US 2014/0342747 A1
(43) Pub. Date: Nov. 20, 2014

(54) DEVICE-TO-DEVICE COMMUNICATION METHOD AND A DEVICE THEREFOR

(71) Applicant: LG ELECTRONICS INC., Seoul (KR)

(72) Inventors: Jihyun Lee, Anyang-si (KR); Hanbyul Seo, Anyang-si (KR); Hakseong Kim, Anyang-si (KR); Inkwon Seo, Anyang-si (KR)

(21) Appl. No.: 14/370,192

(22) PCT Filed: Jan. 18, 2013
(86) PCT No.: PCT/KR2013/000430

§ 371 Date: Jul. 1, 2014

Related U.S. Application Data
(60) Provisional application No. 61/588,171, filed on Jan. 18, 2012.
(60) Provisional application No. 61/674,384, filed on Jul. 22, 2012.

(51) Int. Cl. H04W 72/04; H04W 76/02

(52) U.S. Cl. CPC H04W 72/0453; H04W 76/023
USPC 455/450

(57) ABSTRACT

The present invention relates to a method for performing device-to-device (D2D) communication by a first terminal and a second terminal in a wireless communication system. The method includes: receiving a D2D communication setup response message including resource region information for the D2D communication from a base station; determining, based on the resource region information, whether to switch an operation frequency band of the first terminal from a first frequency band to a second frequency band; and performing the D2D communication with the second terminal at the first frequency band or the second frequency band according to the determined result, wherein either the first frequency band or the second frequency band may be used for transmission in the D2D communication and the other may be used for reception in the D2D communication.

### TECHNICAL FIELD

The present invention relates to a wireless communication system and, more particularly, to a method for performing user equipment (UE)-to-UE communication and device-to-device (D2D) communication, a method for supporting D2D communication and a device therefor.

### BACKGROUND ART

In cellular communication, a user equipment (UE) existing in a cell accesses a base station to receive control information for exchanging data from the base station in order to perform communication and then transmit and receive data. That is, since the UE transmits and receives data via the base station, the UE transmits data to the base station in order to transmit the data to another cellular UE and the base station, which has received the data, transmit the received data to another UE. Since the UE must transmit data to another UE via the base station, the base station schedules channels and resources for data transmission and reception and transmits channels and resource scheduling information to each UE. In order to perform UE-to-UE communication via a base station, the base station needs to allocate channels and resources for transmitting and receiving data to each UE. However, in D2D communication, a UE directly transmits and receives a signal to a desired UE without using a base station or a relay.

If UE-to-UE communication or D2D communication for directly transmitting and receiving data between UEs is performed by sharing resources with an existing cellular network, each UE may perform UE-to-UE communication after resource allocation for UE-to-UE communication. However, in communication between UEs using different frequencies, it is necessary to determine operating frequencies upon resource allocation. That is, one of first and second UEs, which subscribe to different communication operators, may move to an operating frequency of a peer UE or D2D communication is performed at a third frequency.

### DISCLOSURE

### Technical Problem

An object of the present invention devised to solve the problem lies in a method for determining an operating frequency of each UE for D2D communication.

Another object of the present invention devised to solve the problem lies in a method for determining a transmission/reception time of a UE pair for D2D communication.

The technical problems solved by the present invention are not limited to the above technical problems and other technical problems which are not described herein will become apparent to those skilled in the art from the following description.

### Technical Solution

The object of the present invention can be achieved by providing a method for, at a first user equipment (UE), performing device-to-device (D2D) communication with a second UE in a wireless communication system including receiving a D2D communication setup response message including resource region information for D2D communication from a base station, determining whether or not to switch an operating frequency band of the first UE from a first frequency band to a second frequency band based on the resource region information, and performing the D2D communication with the second UE in the first frequency band or the second frequency band according to the result of determination, wherein one of the first frequency band or the second frequency band is used for transmission for the D2D communication and another is used for reception for the D2D communication.

Additionally or alternatively, the transmission for the D2D communication may be performed in the first frequency band and the reception for the D2D communication may be performed in the second frequency band.

Additionally or alternatively, the transmission for the D2D communication may be performed in the second frequency band and the reception for the D2D communication may be performed in the first frequency band.

Additionally or alternatively, the resource region information may include information on a period for D2D communication and a frequency for the D2D communication.

Additionally or alternatively, the operating frequency band may be switched at a time when switching between the transmission and the reception for the D2D communication is occurred by the first UE or the second. UE, and the time is indicated by information on a period for the D2D communication included in the resource region information.

Additionally or alternatively, the method may further include switching the operating frequency band to the second frequency band indicated by the resource region information.

Additionally or alternatively, the performing the D2D communication may further include monitoring a control channel for the D2D communication and receiving reception control information or transmission control information.

Additionally or alternatively, the D2D communication setup response message may further include information on a search space and a scrambling identifier of a control channel for D2D communication.

In another aspect of the present invention, provided herein is a user equipment (UE) configured for perform device-to-device (D2D) communication with a peer UE in a wireless communication system including a radio frequency (RF) unit configured to transmit or receive an RF signal and a processor configured to control the RF unit.

The processor may be configured to receive a D2D communication setup response message including resource region information for the D2D communication from a base station via the RF unit, to determine whether or not to switch an operating frequency band of the first UE from a first frequency band to a second frequency band based on the resource region information, and to perform the D2D communication with the peer UE in the first frequency band or the second frequency band according to the result of determination, and wherein one of the first frequency band or the second frequency band is used for transmission for the D2D communication and another is used for reception for the D2D communication.

Additionally or alternatively, the transmission for the D2D communication may be performed in the first frequency band and the reception for the D2D communication may be performed in the second frequency band.

Additionally or alternatively, the transmission for the D2D communication may be performed in the second frequency band and the reception for the D2D communication may be performed in the first frequency band.

Additionally or alternatively, the resource region information may include information on a period for the D2D communication and a frequency for the D2D communication.

Additionally or alternatively, the operating frequency band may be switched at a time when switching between the transmission and the reception is occurred by the first UE or the second UE, and the time may be indicated by information on a period for the D2D communication included in the resource region information.

Additionally or alternatively, the operating frequency band may be switched to the second frequency band indicated by the resource region information.

Additionally or alternatively, the processor may monitor a control channel for the D2D communication and receive reception control information or transmission control information.

Additionally or alternatively, the D2D communication setup response message may further include information on a search space and a scrambling identifier of a control channel for D2D communication.

In another aspect of the present invention, provided herein is a method for, at a base station, supporting device-to-device (D2D) communication between a first user equipment (UE) and a second UE in a wireless communication system including transmitting a D2D communication setup response message including resource region information for the D2D communication to the first UE or the second UE, wherein the resource region information includes information on a first frequency band and a second frequency band corresponding to an operating frequency band for the D2D communication, wherein one of the first frequency band or the second frequency band is used for transmission for the D2D communication and another is used for reception for the D2D communication.

In another aspect of the present invention, provided herein is a base station configured to support device-to-device (D2D) communication between a first user equipment (UE) and a second UE in a wireless communication system including a radio frequency (RF) unit configured to transmit or receive an RF signal and a processor configured to control the RF unit, wherein the processor is configured to transmit a D2D communication setup response message including resource region information for D2D communication to the first UE or the second UE via the RF unit, wherein the resource region information includes information on a first frequency band and a second frequency band corresponding to an operating frequency band for D2D communication, and wherein one of the first frequency band or the second frequency band is used for transmission for the D2D communication and another is used for reception for the D2D communication.

It is to be understood that both the foregoing general description and the following detailed description are merely exemplary of the invention, and are intended to provide an overview or framework for understanding the nature and character of the invention as it is claimed.

### Advantageous Effects

According to one embodiment of the present invention, it is possible to determine an operating frequency of each UE for D2D communication to easily perform D2D communication. In addition, it is possible to determine a transmission/reception time of a UE pair for D2D communication to efficiently perform D2D communication.

It will be appreciated by persons skilled in the art that that the effects that can be achieved through the present invention are not limited to what has been particularly described hereinabove and other advantages of the present invention will be more clearly understood from the following detailed description.

### Description of Drawings

The accompanying drawings, which are included to provide a better understanding of the invention, illustrate embodiments of the invention and together with the description serve to explain the principle of the invention.

FIG. 1 is a diagram showing an example of a radio frame structure used in a wireless communication system.

FIG. 2 is a diagram showing an example of a downlink (DL)/uplink (UL) slot structure in a wireless communication system.

FIG. 3 is a diagram showing a downlink subframe structure used in a 3^{rd} Generation Partnership Project (3GPP) long term evolution (LTE) (-A) system.

FIG. 4 is a diagram showing an uplink subframe structure used in a 3^{rd} Generation Partnership Project (3GPP) long term evolution (LTE) (-A) system.

FIG. 5 is a diagram showing a network structure of D2D communication according to one embodiment of the present invention.

FIG. 6 is a diagram showing a discovery procedure for D2D communication according to one embodiment of the present invention.

FIG. 7 is a diagram showing a setup procedure for D2D communication according to one embodiment of the present invention.

FIG. 8 is a diagram showing a D2D period according to one embodiment of the present invention.

FIG. 9 is a diagram showing an example of indicating a resource region for D2D communication via a control channel of a peer base station (eNodeB2) according to one embodiment of the present invention.

FIG. 10 is a diagram showing an example of indicating a resource region for D2D communication via a control channel of a peer base station (eNodeB2) according to one embodiment of the present invention.

FIG. 11 is a diagram showing an example of operating frequency switching for D2D communication according to one embodiment of the present invention.

FIG. 12 is a diagram showing an example of operating frequency switching for D2D communication according to one embodiment of the present invention.

FIG. 13 is a diagram showing an example of synchronization in a D2D period according to one embodiment of the present invention.

FIG. 14 is a diagram showing an example of setting a transmission/reception time of each UE according to one embodiment of the present invention.

FIGS. 15 and 16 are diagrams showing a D2D setup and communication procedure according to one embodiment of the present invention.

FIG. 17 is a diagram showing a resource renegotiation procedure for D2D setup, D2D communication and D2D communication between base stations according to one embodiment of the present invention.

FIG. 18 is a block diagram showing a device configured to perform operation related to D2D communication according to one embodiment of the present invention.

### BEST MODE

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

Also, technique, device, system, which will be described hereinafter, may be applied to various wireless multiplexing access systems. For convenience of description, it is assumed that the present invention is applied to a 3GPP LTE(-A). However, it is to be understood that technical features of the present invention are limited to the 3GPP LTE(-A). For example, although the following description will be made based on a mobile communication system corresponding to a 3GPP LTE(-A) system, the following description may be applied to other random mobile communication system except matters specific to the 3GPP LTE(-A).

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’ , ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowlegement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

Also, in the present invention, Cell-specific Reference Signal (CRS)/Demodulation Reference Signal (DMRS)/Channel State Information Reference Signal (CSI-RS) time-frequency resources (or REs) respectively mean REs that may be allocated or used for CRS/DMRS/CSI-RS, or time-frequency resources (or REs) carrying CRS/DMRS/CSI-RS. Also, subcarriers that include CRS/DMRS/CSI-RS RE may be referred to as CRS/DMRS/CSI-RS subcarriers, and OFDM symbols that include CRS/DMRS/CSI-RS RE may be referred to as CRS/DMRS/CSI-RS symbols. Also, in the present invention, SRS time-frequency resources (or REs) may mean time-frequency resources (or REs) transmitted from the user equipment to the base station to allow the base station to carry a sounding reference signal (SRS) used for measurement of an uplink channel status formed between the user equipment and the base station. The reference signal (RS) means a signal of a special waveform previously defined and known well by the user equipment and the base station, and may be referred to as a pilot.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE.

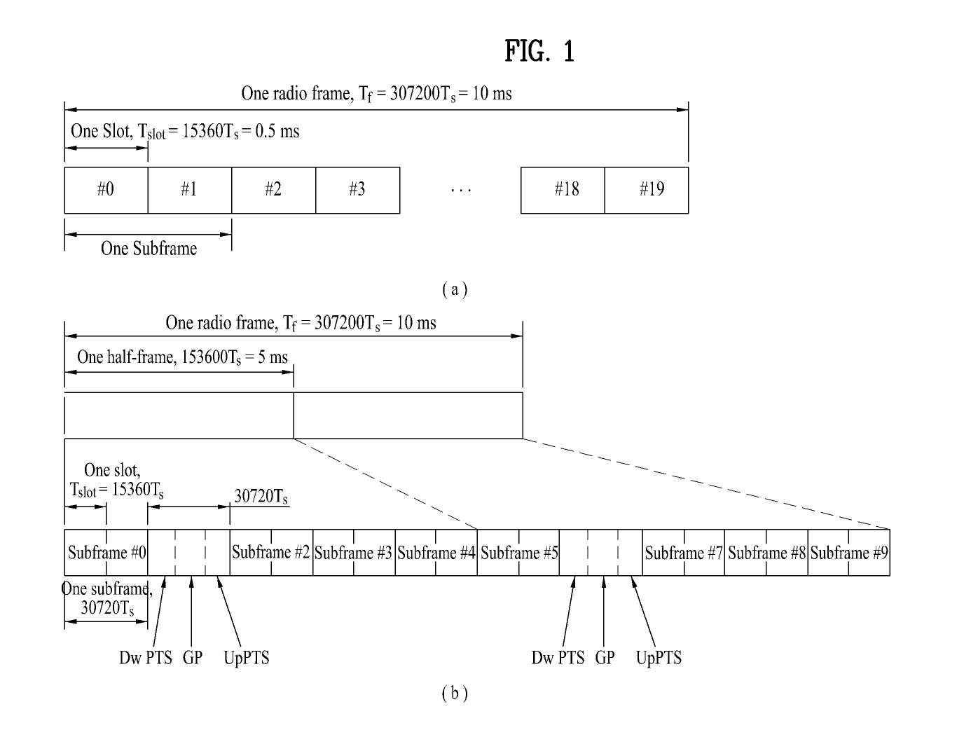

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| DL-UL | Downlink- | | | | | | | | | | | |
|---|---|---|---|---|---|---|---|---|---|---|---|---|
| con- | to-Uplink | | | | | | | | | | | |
| figura- | Switch-point | | Subframe number | | | | | | | | | |
| tion | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

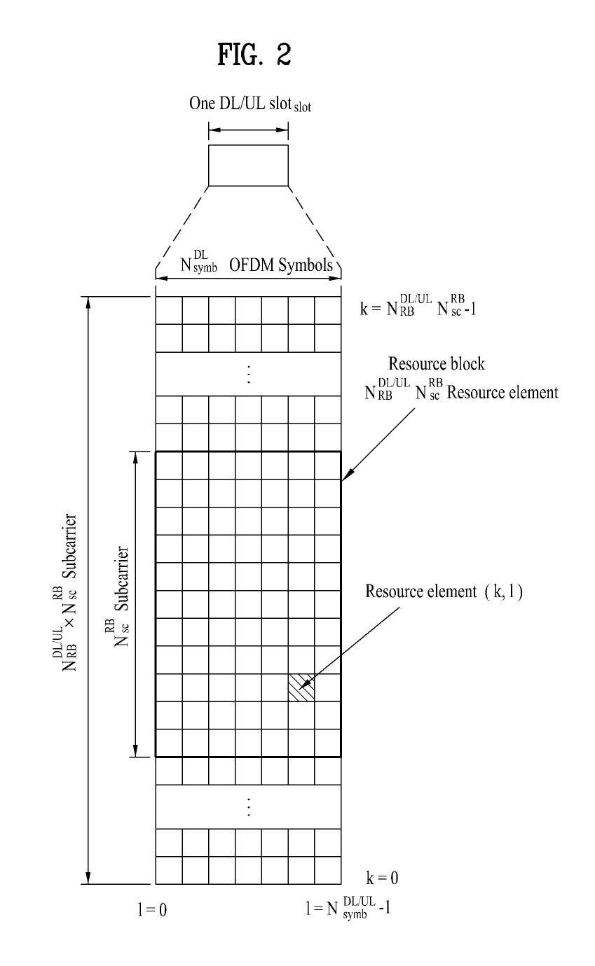

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and RB denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g. 7) consecutive OFDM symbols in the time domain and N_{sc}^{RB} (e.g. 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. The two RBs constituting the PRB have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, n_{PRB}=n_{VRB} is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

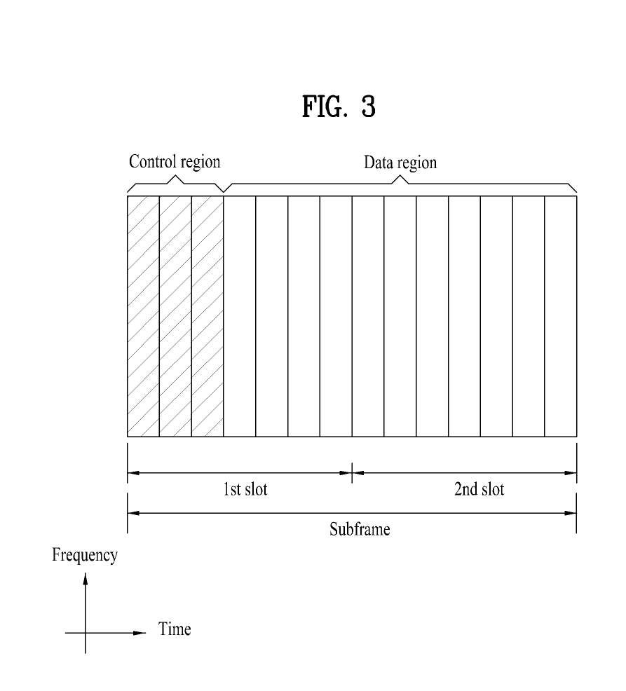

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PH1CH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate.

A plurality of PDCCHs may be transmitted in a PDCCH region of a DL subframe. A UE may monitor a plurality of PDCCHs. A BS decides a DCI format according to DCI to be transmitted to a UE and attaches a cyclic redundancy check (CRC) to the DCI. The CRC is masked with an identifier (e.g., a Radio Network Temporary Identifier (RNTI)) according to an owner or usage of the PDCCH. If the PDCCH is for a specific terminal, a cell-RNTI (C-RNTI) of the terminal may be masked to the CRC. Alternatively, if the PDCCH is for a paging message, a paging indicator identifier (P-RNTI) may be masked to the CRC. If the PDCCH is for system information (more specifically, a system information block (SIB)), a system information identifier and a system information RNTI (SI-RNTI) may be masked to the CRC. If the PDCCH is for a random access response, a random access-RNTI (RA-RNTI) may be masked to the CRC. CRC masking (or scrambling) includes an XOR operation of a CRC and an RNTI at a bit level, for example.

A PDCCH is transmitted on one control channel element (CCE) or an aggregate of a plurality of consecutive CCEs. The CCE is a logical allocation unit used to provide a coding rate to a PDCCH based on a radio channel state. The CCE corresponds to a plurality of resource element groups (REGs). For example, one CCE corresponds to nine REGs and one REG corresponds to four REs. Four QPSK symbols are mapped to each REG. An RE occupied by an RS is not included in an REG. Accordingly, the number of REGs within a given OFDM symbol is changed according to presence/absence of an RS. The REG concept is also used for other DL control channels (that is, a PCFICH and a PHICH). A DCI format and the number of DCI bits are determined according to the number of CCEs.

CCEs are numbered and consecutively used and, in order to simplify decoding, a PDCCH having a format composed of n CCEs may start from only a CCE having a number corresponding to a multiple of n. The number of CCEs used to transmit a specific PDCCH, that is, a CCE aggregation level, is determined by a BS according to a channel state. For example, in case of a PDCCH for a UE having a good DL channel (e.g., a UE adjacent to a BS), one CCE may be sufficient. However, in case of a PDCCH for a UE having a bad channel (e.g., a UE located at a cell edge), 8 CCEs are required to obtain sufficient robustness.

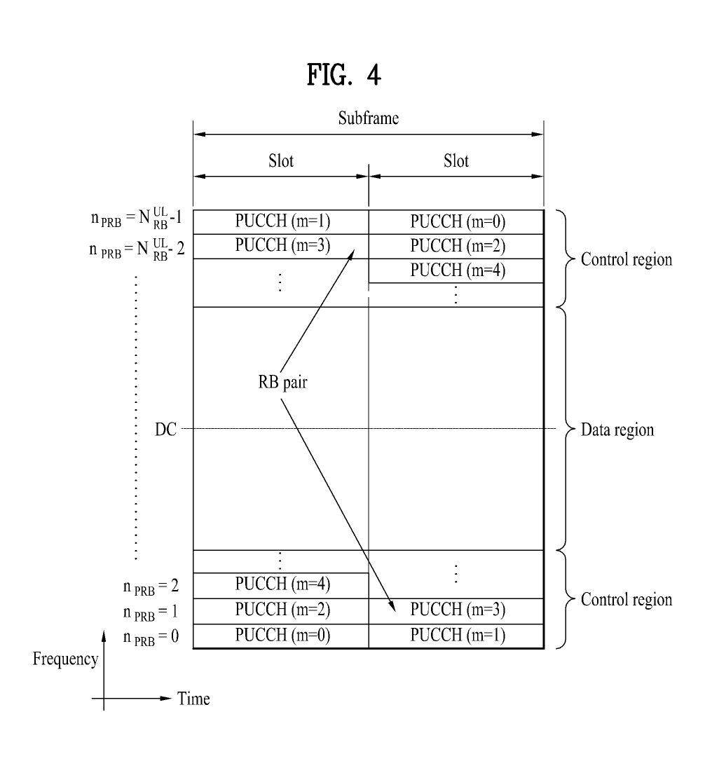

FIG. 4 is a diagram showing an example of an uplink subframe structure used in a 3GPP LTE(-A) system.

Referring to FIG. 4, a UL subframe may be divided into a control region and a data region in a frequency domain. One or several physical uplink control channels (PUCCHs) may be allocated to the control region in order to carry uplink control information (UCI). One or several physical uplink shared channels (PUCCHs) may be allocated to the data region of the UL subframe in order to carry user data. The control region and the data region in the UL subframe are also referred to as a PUCCH region and a PUSCH region, respectively. A sounding reference signal (SRS) may be allocated to the data region. The SRS is transmitted on a last OFDM symbol of a UL subframe in a time domain and is transmitted on a data transmission band, that is, a data region, of the UL subframe. SRSs of several UEs, which are transmitted/received on the last OFDM symbol of the same subframe, are distinguished according to frequency location/sequence.

If a UE employs an SC-FDMA scheme in UL transmission, in order to maintain a single carrier property, in a 3GPP LTE release-8 or release-9 system, a PUCCH and a PUSCH may not be simultaneously transmitted on one carrier. In a 3GPP LTE release-10 system, support of simultaneous transmission of a PUCCH and a PUSCH may be indicated by a higher layer.

In a UL subframe, subcarriers distant from a direct current (DC) subcarrier are used as the control region. In other words, subcarriers located at both ends of a UL transmission bandwidth are used to transmit uplink control information. A DC subcarrier is a component which is not used to transmit a signal and is mapped to a carrier frequency f0 in a frequency up-conversion process. A PUCCH for one UE is allocated to an RB pair belonging to resources operating in one carrier frequency and RBs belonging to the RB pair occupy different subcarriers in two slots. The allocated PUCCH is expressed by frequency hopping of the RB pair allocated to the PUCCH at a slot boundary. If frequency hopping is not applied, the RB pair occupies the same subcarrier.

The size and usage of UCI carried by one PUCCH may be changed according to PUCCH format and the size of the UCI may be changed according to a coding rate. For example, the following PUCCH format may be defined.

TABLE 2

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK | |
| | | | or CQI/PMI/RI + | |
| | | | ACK/NACK | |

Referring to Table 2, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

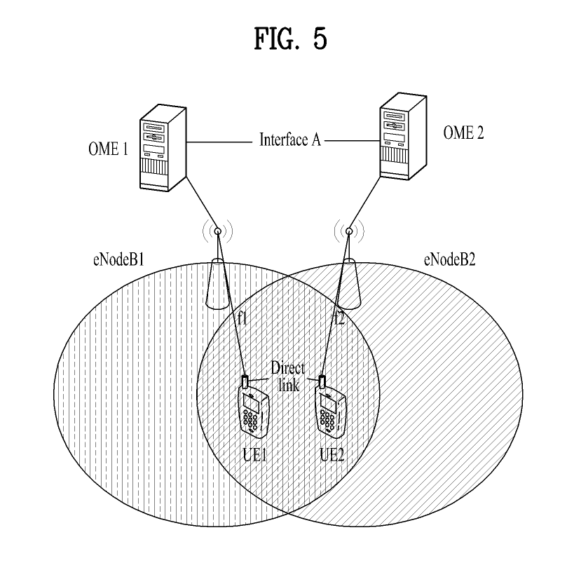

FIG. 5 is a diagram showing a network structure of D2D communication according to one embodiment of the present invention. D2D communication refers to a wireless communication scheme for directly communicating between a UE (UE1) for performing a transmission operation and a UE (UE2) for performing a reception operation, both of which are located in transmission coverage thereof, without participation of base stations (eNodeBs). The present invention particularly proposes a D2D communication method when the UE1 and the UE2 subscribe to different wireless communication operators. In general, since individual wireless communication operators provide communication at different frequencies, the UE1 and UE2, which respectively subscribe to different communication operators, operate at different frequencies in general communication (that is, communication with an eNodeB).

The UE1 is served by a first base station (eNodeB1) connected to an operator management entity (OME) of a first operator and the UE2 is served by a second base station (eNodeB2) connected to an OME of a second operator. The OME of the first operator and the OME of the second operator are connected to each other via an interface A. The UE1 and the UE2 communicate with the base stations thereof at frequencies f1 and f2, respectively. Since the UE1 and the UE2 perform D2D communication, each UE includes a transmitter and receiver operable at the frequencies f1 and f2.

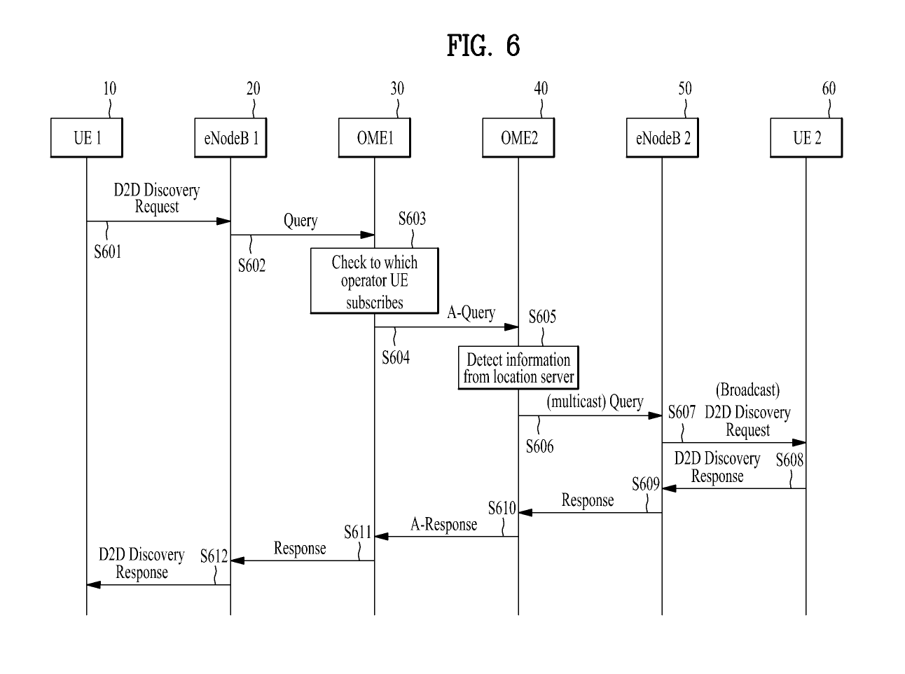

FIG. 6 is a diagram showing a discovery procedure for D2D communication according to one embodiment of the present invention. For D2D communication between UEs, there is a need for a process of discovering a counterpart UE (that is, a peer UE). Peer UE discovery is a process of querying a peer UE to check whether the peer UE has D2D communication capabilities and determining to which operator a network, to which the peer UE is connected or subscribes, belongs.

For peer UE discovery, the UE1 10 may discover a peer UE via eNodeBs. Such a discovery method is efficiently used to discover UE serviced by another operator. For peer UE discovery, the UE1 10 may transmit a D2D discovery request message to the eNodeB1 20 (S601). The D2D discovery request message may include the following information elements.
UE ID
UE MAC address
Peer UE ID

The UE ID is an identifier (ID) of a UE (that is, a discovery requester) for transmitting the D2D discovery request message, the UE MAC address is the MAC address of the UE, and the peer UE ID is the ID of a peer UE which is a D2D communication counterpart specified by the discovery requester.

The eNodeB1 20, which has received the request message from the UE1 10, may transmit, to the first OME 30 of the operator registered therewith, a message for querying subscription of the peer UE (S602).

The OME may perform an access control and data routing/forwarding function between networks while operating as a gateway between networks of different operators. In addition, the OME may store information on UEs subscribing to the operator registered therewith or have an interface with a location server configured to store information on the UEs. For example, in an LTE(-A) system, the OME may be defined as a mobility management entity(MME) or a serving gateway (SGW) or may defined as a logical entity having an interface with the MME or the SGW. The query (or the query message) transmitted by the eNodeB1 may include the ID of the peer UE and/or the ID of the eNodeB1.

When the query message is received, the first OME 30 may check to which operator the peer UE (in the present embodiment, the UE2 60) subscribes (S603). In order to check to which the operator the peer UE subscribes, if the first OME 30 knows information on the operator of the UE2 60, the first OME 30 may forward the query message to an OME (in the present embodiment, a second OME 40) of the operator of the UE2 60 (S604). The delivered query message is defined in the interface A between the OMEs and is referred to as A-query. The A-query may further include information on the first OME 30 for transmitting the A-query.

When the A-query is received from the first OME 30 which is the OME of another operator, the second OME 40 may check whether the UE2 60 subscribes thereto or has D2D communication capabilities. The UE registers user related information and subscription related information with the OME or the location server when first attempting to access the network. The user related information may include a UE ID, D2D capabilities or information indicating whether the D2D function is enabled and the subscription related information may include operator information. Accordingly, the second OME 40 may detect information on the UE2 60 therefrom or from the location server (S605).

If the UE2 60 does not subscribe to the second OME 40 or does not have D2D capabilities or if the D2D function is not enabled, the second OME 40 may discard the A-query from the first OME 30 or transmit a response message indicating that the request for the query has failed. If the UE2 60 subscribes to the second OME 40, the second OME 40 may deliver the query message to candidate eNodeBs which serve the peer UE (S606). Information on the candidate eNodeBs may be managed by the OME or the location server. When the query message is received, the eNodeB2 50 may broadcast a D2D discovery request message (S607).

The D2D discovery request message may include the ID of the UE2 60 (that is, the ID of the peer UE). For example, a PDCCH having an RNTI value corresponding to the D2D discovery request is included in a downlink subframe transmitted by the request message and thus the ID of the UE2 60 may be delivered in a region indicated by the PDCCH. The UE2 60 may monitor the PDCCH from eNodeB 50 and check whether the D2D discovery request is made. The UE2 60 should monitor the RNTI value allocated to the D2D discovery request in the PDCCH. If the D2D discovery request is made, the UE2 may check whether the ID of the UE of the region indicated by the PDCCH matches the ID thereof. In order to reduce overhead for monitoring the PDCCH, the D2D discovery request message may be directly transmitted to the UE via UE-specific signaling if a UE ID matching the ID of the peer UE included in the query message is present in the IDs of the UEs managed by the eNodeB2 50.

When the ID value of the peer UE of the D2D discovery request message matches the ID of the UE2, the UE2 60 may transmit a D2D discovery response message as a response to the request (S608). The D2D discovery response message may include the ID of the responder (in the present embodiment, the UE2 60). When the D2D discovery response message is received, the eNodeB2 50 may transmit the D2D discovery response message including the ID thereof to the second OME 40 to which the eNodeB2 subscribes (S609). When the D2D discovery response message is received, the second OME 40 may determine that the peer UE for D2D communication has been successfully discovered and transmit an A-response message to the first OME 30 (S610). The A-response message may include operator identifier information managed by the second OME 40, frequency information managed by the operator, operating frequency information of an eNodeB which serves the peer UE (or frequency resources allocated for D2D communication among the operating frequencies of the eNodeB which serves the peer UE).

When the A-response message is received, the first OME 30 may transmit a response message to the eNodeB1 20 (S611). The response message may include ID and operating frequency related information of the peer UE, the peer eNodeB and/or the peer OME (in the present embodiment, the UE2 60, the eNodeB2 50 and the second OME 40).

When the response message is received, the eNodeB1 20 may transmit a D2D discovery response message to the UE1 10 (S612). The D2D discovery response message may include the following information elements.
Peer UE ID
Peer UE MAC address
Peer UE operator information (e.g., carrier frequency and/or operating bandwidth, cell ID, etc.)
Peer UE operating frequency (and/or bandwidth allocated for D2D communication)

The peer UE ID is an identifier of a peer UE (that is, a discovery responder) for transmitting the D2D discovery response message, the peer UE MAC address is the MAC address of the peer UE, the peer UE operator information is information related to the operator to which the peer UE subscribes, and the peer UE operating frequency is the operating frequency of the peer UE.

In the D2D communication discovery process, a timeout value may be set in order to prevent the UE, the eNodeB and the OME from continuously standing by until the response is received. The timeout value refers to a time interval when the UE1 10, the eNodeB1 20 and the first OME 30 corresponding to the requester entity stand by until the response to the A-query message is received. When the timeout value expires before the response is received, the request is regarded as having failed. The timeout value may be explicitly included in each message to be transmitted along with other information elements or may be separately configured to use a predetermined value in each entity.

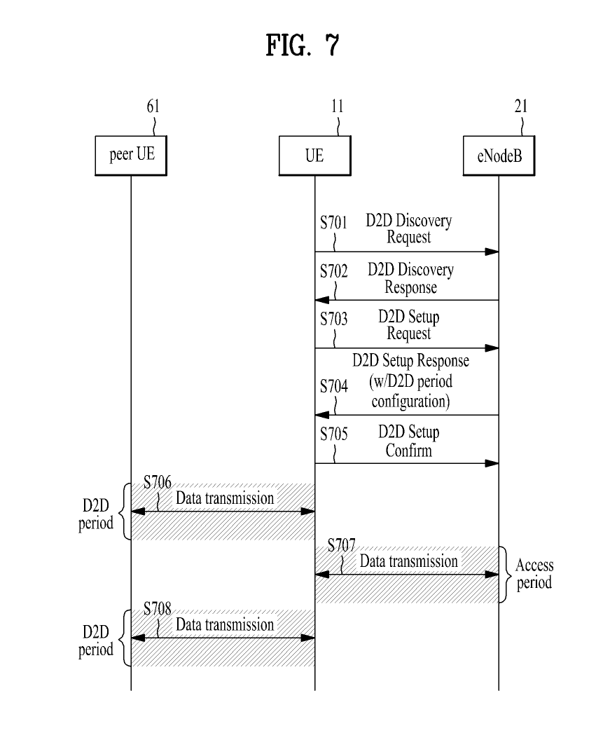

If the D2D communication counterpart discovery process is completed, then a link setup procedure for D2D communication is performed. FIG. 7 is a diagram showing a setup procedure for D2D communication according to one embodiment of the present invention. In FIG. 7, S701 and S702 correspond to S601 and S612 of FIG. 6 and a description thereof will be omitted.

The UE 11 may transmit a D2D setup request message to the eNodeB 21 (S703). At this time, the UE 11 may transmit the D2D discovery response message or receive the D2D discovery response message. That is, the UE 11 may be the UE1 10 or UE2 60 shown in FIG. 6.

The D2D setup request message may include the following information elements.
UE ID
UE operator information
Peer UE ID
Peer UE operator information
D2D period which consists of 3 fields: start time, period and interval (optional)

The UE ID is the IE of the UE (that is, the requester) for transmitting the D2D setup request message, the UE operator information is information related to the operator to which the UE subscribes, the peer UE ID is the ID of the peer UE of D2D communication, the peer UE operator information is information related to the operator to which the peer UE subscribes, and the D2D period is optional and corresponds to a period for D2D communication.

When the D2D setup request message is received, the eNodeB 21 may allocate a D2D resource region and set a period for D2D communication. That is, the eNodeB 21 may allocate time-frequency resources for D2D communication. The period for D2D communication set by the eNodeB 21 may be equal to the D2D period field included in the D2D setup request message. The eNodeB 21 may transmit a D2D setup request message to the UE 11 in response to the D2D setup request message (S704). In addition, the eNodeB 21 may deliver the D2D setup response message including information on the period for D2D communication and the D2D resource region to a peer eNodeB (not shown).

The D2D setup response message may include the following information elements.
Status code
Peer UE ID
D2D period which consists of 3 fields: start time, period and interval
D2D resource region

The status code indicates whether the D2D setup request has been granted or failed, the peer UE ID indicates the ID of the peer UE, the D2D period indicates period information for D2D communication, and the D2D resource region indicates a time-frequency resource region for D2D communication. The D2D resource region may include carrier information allocated to D2D communication. In addition, if a control channel for D2D communication is present, the d2D resource region may include information related to the control channel. The information related to the control channel may include carrier information and/or search space information. The UE 11 or the peer UE 61 may switch to the frequency of a carrier indicated in the D2D resource region to monitor the control channel.

More specifically, the carrier information may be a frequency managed by the operator to which the peer UE subscribes or a third frequency, use of which by the UE 11 and the peer UE 61 is licensed, or an unlicensed frequency. In addition, the control channel related information refers to information on a resource region in which the control channel is transmitted. The control channel may be transmitted by the peer eNodeB or may be directly transmitted by the peer UE. The control channel related information may include a carrier frequency at which the control channel is transmitted. The carrier frequency at which the control channel is transmitted may be equal to information on the operating frequency of the peer UE included in the D2D discovery response message. At this time, the D2D resource region may include search space information of the control channel and the RNTI value of the control channel, in order to enable the UE 11 to decode the control channel at the carrier frequency for D2D communication.

Alternatively, the UE 11 may immediately perform synchronization with the UE 61 and transmit and receive data for D2D communication without detection or decoding of the control channel. In this case, the D2D resource region may include a seed value (e.g., a C-RNTI) for generating a signal or the location of time/frequency resources used to transmit a data channel or a synchronization signal.

The D2D period is a time interval when the UE 11 stops communication with the eNodeB 21 and communicates with the peer UE 61. The reason why the D2D period is set is because the UE 11 may perform access using one transmitter and receiver at a plurality of operator frequencies but the transmitter and receiver are designed to operate at only one operator frequency at one point of time or the UE 11 has a transmitter and receiver operable at two or more operator frequencies but simultaneous transmission and reception at two operator frequencies may cause interference between transmission at one frequency and reception at the other frequency.

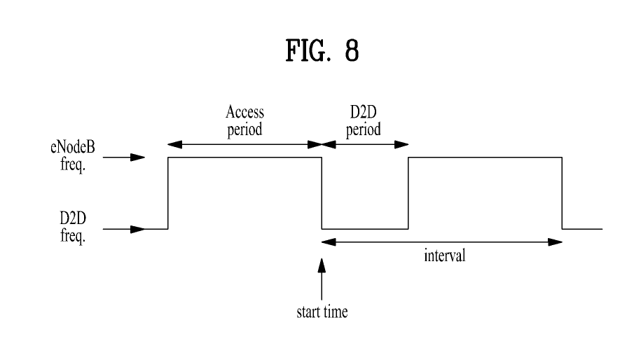

FIG. 8 is a diagram showing a D2D period according to one embodiment of the present invention. FIG. 8 shows switching of the operating frequency of the UE to an eNodeB frequency for communication with the eNodeB in an access period and to a D2D frequency for D2D communication in a D2D period.

The UE 11 stops communication with the eNB 21 for D2D communication and acquires resources for D2D communication. At this time, the UE 11 may start D2D communication in a state of disconnecting a link with the eNodeB 21 or may perform D2D communication in a state of maintaining the link. If the link is maintained, the UE 11 may not perform communication with the eNodeB 21 in the D2D communication period. Accordingly, while the UE 11 operates for D2D communication, the eNodeB 21 does not schedule data transmission between the eNodeB 21 and the UE 11.

If the UE 11 includes a transmitter and receiver operable at dual radio frequencies and performs simultaneous transmission at different operator frequencies, the D2D period information element may not be included in the D2D setup request/response message. In this case, one radio frequency may be used for communication with the eNodeB 21 and the other radio frequency may be used for D2D communication. If the D2D period is not included as the information element, it may be determined that the radio frequency used for D2D communication may be continuously used.

Even when the UE 11 may perform simultaneous transmission at different operator frequencies, the D2D period information element may be included in the D2D setup request/response message. In this case, the radio frequency unit used for D2D communication sleeps in the access period. That is, for battery saving of the UE 11, the RF unit of a frequency band for D2D communication is turned off in the access period.

When the D2D setup response message is received, the UE 11 may transmit a D2D setup confirmation message to the eNodeB 21 (S705). The D2D setup confirmation message may include the following information element.
Status code

The status code indicates whether the D2D setup request has been granted or failed.

In addition, when the D2S setup response message is received and the status code is granted, the UE 11 may switch the frequency thereof to the frequency indicated by the peer UE operating frequency in a region set to the D2D period. At this time, the UE 11 may be configured to signal a value indicating the D2D period of the D2D setup response message via radio resource control (RRC) signaling. The UE 11 switches the frequency thereof to a frequency specified in a specific period (time or interval) according to new setup. The UE 11, which has switched the frequency thereof, may receive a control channel at the switched frequency and perform D2D data communication (S706 and S708). The UE 11 may perform data communication with the eNodeB 21 in the access period (S707).

Steps S706, S707 and S708 may be implemented in order different from that shown in FIG. 7 and at least one step may be omitted.

If the UE 11 includes a transmitter and receiver operable at dual radio frequencies and performs simultaneous transmission at different operator frequencies, then the D2D period for the UE 11 need not to be set. Accordingly, the UE 11 may switch the frequency thereof to the frequency indicated by the peer UE operating frequency information element immediately after the D2D setup confirmation message is transmitted or at a desired time. When frequency switching is completed, the control channel may be monitored.

In a system having an asynchronous distributed coordination function (DCF) based protocol, such as IEEE 802.11, when the UE performs frequency switching, a medium may be held in idle mode at the switched frequency to perform D2D communication. In contrast, in a synchronous system such as 3GPP LTE(-A), a UE reception (or transmission) time and a peer UE transmission (or reception) time should be individually set to match each other. Accordingly, OMEs need to negotiate with each other such that D2D data transmission and reception is performed in a negotiated resource region and a negotiation result needs to be signaled.

In addition, the carrier frequency indicated in the D2D resource region may not match the operator frequency of the UE2 which is the peer UE. For example, D2D control and D2D data may be transmitted on an extension carrier of the eNodeB2 which is the peer eNodeB.

In addition, in the D2D setup process, the eNodeB2 transmits a D2D setup response message including information on the same D2D resource region as that transmitted from the eNodeB1 to the UE1 in an unsolicited state. The UE2, which has received the unsolicited D2D setup response message, may broadcast an advertisement signal including the ID thereof. The UE2, which has received the advertisement signal, directly establishes the link with the peer UE and exchanges data. At this time, the advertisement signal may include resource region information for D2D data transmission.

The D2D communication process S706 and S708 will now be described in greater detail. The UE 11 switches the operating frequency thereof to the peer UE operating frequency in the D2D period. Then, the UE 11 detects a synchronization signal (SS) transmitted by the peer eNodeB (the eNodeB which serves the peer UE) at the frequency and synchronizes with the peer eNodeB. Subsequently, the UE 11 may decode a broadcast channel (BCH) transmitted by the peer eNodeB to receive broadcast information (master/system information) of the peer eNodeB.

The UE 11, which has synchronized with the peer eNodeB, may acquire information on the D2D resource region from the peer eNodeB. The UE 11, which has switched the operating frequency thereof to the operator frequency of the peer UE, receives a control channel from the peer eNodeB. The control channel includes information on the resource region allocated for D2D data transmission and reception. The control channel may be decoded by both the UE 11 and the peer UE 61 and data transmission and reception between the UEs is performed in the resource region indicated by the control channel (S706 and S708).

For example, information on the D2D resource region may be transmitted via a D2D PDCCH. Here, the D2D PDCCH is configured for D2D communication and refers to a channel transmitted from the eNodeB to the UE 11 and peer UE 61 participating in D2D communication. The D2D PDCCH includes resource allocation information for D2D communication and may follow the configuration and format of a PDCCH for general LTE(-A) communication between the UE and the eNodeB unless stated otherwise.

The UE 11 must acquire information for decoding the D2D PDCCH in advance. Information for decoding includes information on a resource region (e.g., a PDCCH search space) in which a control channel is transmitted and a scrambling ID (e.g., D2D-RNTI) information necessary for decoding. Such information may be acquired via a D2D resource region information element included in a D2D setup response message in a setup process for D2D communication. The peer UE 61 may acquire related information in a process of being connected to the peer eNodeB (the eNodeB which serves the peer UE) (not shown) or via RRC connection.

For example, in FIG. 7, the UE may receive a control channel (or a D2D PDCCH) for D2D communication transmitted by the peer eNodeB after switching to f2 which is the operating frequency of the peer UE 61. Downlink control information (DCI) of the control channel for D2D communication may be defined in a new DCI format. The D2D DCI format may include information on a downlink reception resource region and an uplink transmission resource region of the peer UE 61. The peer UE 61 may transmit data to the UE 11 via the downlink of the peer UE 61 and the peer UE 61 may receive data from the UE 11 via the uplink of the peer UE 61. The downlink and uplink of the UE 11 correspond to the uplink and downlink of the peer UE 61. That is, in the embodiment of the present invention, the uplink for D2D communication refers to a link for transmitting data to the peer UE at one UE and the downlink for D2D communication refers to a link for receiving data from the peer UE at one UE.

When the UE 11 receives the D2D PDCCH from the peer eNodeB, the uplink/downlink resource region of the peer UE 61 may be confirmed. Accordingly, the UE 11 may transmit data to the peer UE 61 in the reception region of the peer UE 61 and receive data from the peer UE 61 in the transmission region of the peer UE 61.

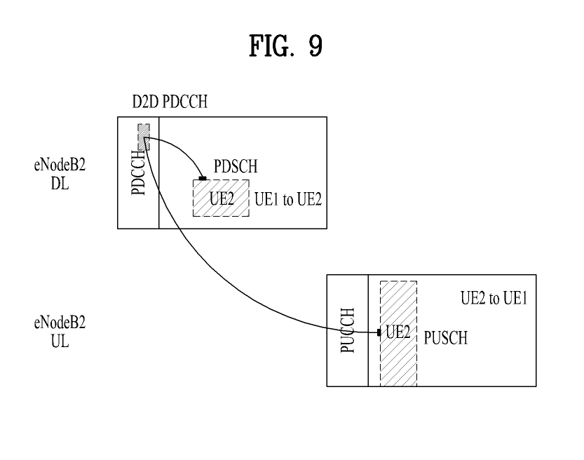

FIG. 9 is a diagram showing an example of indicating a resource region for D2D communication via a control channel of a peer base station (eNodeB2) according to one embodiment of the present invention. For decoding of the PDCCH, the UE should know the configuration of a search space (SS). The SS refers to information on a candidate resource block or candidate support block group, in which a UE-specific PDCCH is transmitted, in a PDCCH resource region.

The UE2 may acquire the configuration of the SS via RRC signaling because connection with the eNodeB2 is established. The UE1 may acquire the configuration of the SS via RRC signaling similarly to the UE2 if connection with the eNodeB2 is established. The UE1 should acquire information on the SS of the D2D PDCCH via a D2D setup response message before switching to the operating frequency of the UE2, if connection with the eNodeB2 is not established. In this case, the information on the SS is semi-static. The UE1 and the UE2 may blind decode the PDCCH allocated for D2D communication in the SS of the D2D PDCCH.

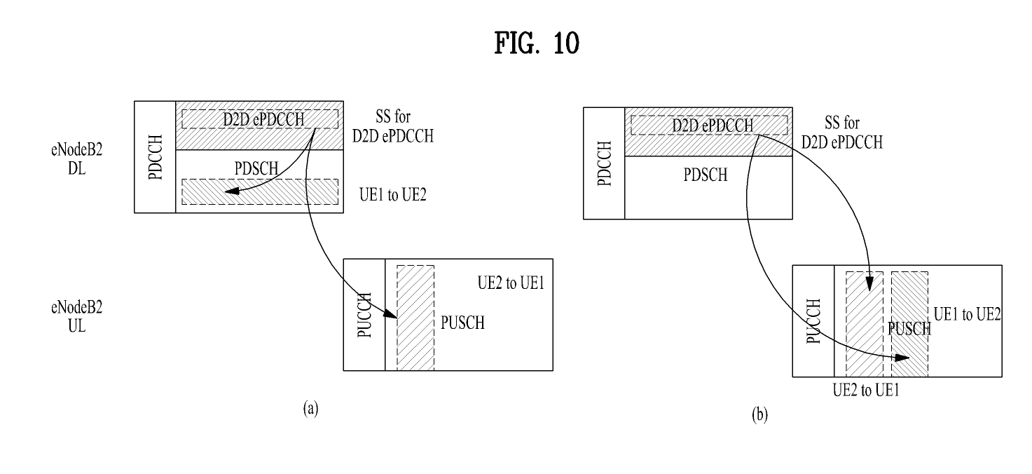

FIG. 10 is a diagram showing an example of indicating a resource region for D2D communication via a control channel of a peer base station (eNodeB2) according to one embodiment of the present invention. Information on the D2D resource region may be transmitted via an enhanced-PDCCH (ePDCCH). The ePDCCH is an extension of a PDCCH to a data region of a downlink subframe and more control channels may be transmitted via the downlink subframe. Accordingly, the ePDCCH may be present in a PDSCH region (that is, a data region) of an existing downlink subframe. In this case, the SS refers to a candidate resource block or resource block group region of a D2D ePDCCH. The SS of the D2D ePDCCH may be configured via RRC signaling similarly to the D2D PDCCH. The UE1 which is not RRC-connected to the eNodeB2 may acquire information on the SS of the D2D ePDCCH via a D2D setup response message. In this case, the information on the SS is semi-static.

When the information on or configuration of the SS is updated, the eNodeB2 may notify the eNodeB1 of the updated information or configuration. The UE1 may receive the information on or configuration of the SS from the eNodeB1 in the access period of FIG. 7. In addition, in the D2D period, the UE1 may receive the updated information or configuration from the UE2 via a direct link to the UE2. In other words, in the D2D period, the UE2 may transmit the D2D ePDCCH to the UE1. When the D2D ePDCCH is received, the UE1 may transmit data for D2D communication to the UE2 in the resource region allocated based on the D2D ePDCCH.

Then, once the UE1 and the UE2 know the SS of the D2D ePDCCH, it is possible to blind decode the D2D ePDCCH in the region of the SS. The D2D ePDCCH may include transmission format information and/or resource allocation information of the D2D uplink (the link from the UE2 to the UE1) and the D2D downlink (the link from the UE1 to the UE2). Each transmission region may be divided into uplink and downlink subframes as shown in FIG. 10(a) or may be defined in an uplink subframe as shown in FIG. 10(b).

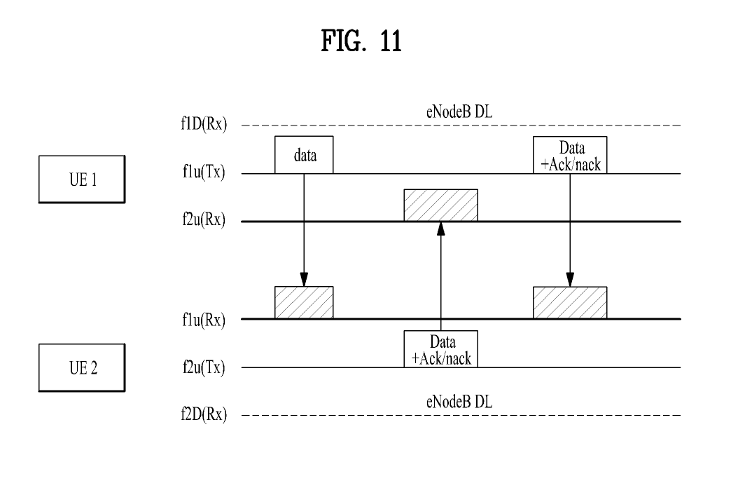

FIG. 11 is a diagram showing an example of operating frequency switching for D2D communication according to one embodiment of the present invention. Even when each UE for D2D communication includes a transmitter/receiver operable at a plurality of different operator frequencies, transmission and reception at all operator frequencies is not necessarily allowed. For example, data transmission of the UE may be allowed only at a frequency managed by the operator, to which the UE subscribes, due to payment policy of the operator. When the UE which does not subscribe to the operator uses the operator frequency for D2D communication without a management system of the operator, the operator cannot impose a payment on the UE, the transmission and reception of the UE which does not subscribe to the operator is not allowed.

Accordingly, if UEs which will perform D2D communication subscribe to different operators, the UEs may receive data but may not transmit data at the frequencies of the different operators. At this time, the UE may be allowed to receive data at the frequency of another operator and thus a transmitter UE may be required to make a payment.

Accordingly, for D2D communication, the UE operates at an operating frequency for data transmission and at an operating frequency for data reception. For example, the UE operates at the frequency of the operator thereof and operates at the frequency of the operator of the peer UE. At this time, the UE may transmit ACK/NAK as well as data. The ACK/NAK relates to data received at the operator frequency of the peer UE.

In FIG. 11, operating frequencies of a transmission operation and a reception operation are different. The UE1 and the UE2 transmit data to each other using a D2D communication method. The downlink and uplink frequencies of the UE1 are respectively f1D and f1u and the downlink and uplink frequencies of the UE2 are respectively f2D and f2u. The UE1 may transmit D2D data to the UE2 as well as uplink data to the eNodeB at f1u. At this time, the resource region of the data transmission to the UE2 may be defined to be orthogonal to the resource region for uplink data to the eNodeB. The UE2 may transmit D2D data to the UE1 at f2u. Symmetrically, the UE 1 may operate in a reception operation at f2u and the UE2 may operate in the reception operation mode at f1u.

Accordingly, when the UE1 knows a data transmission region for D2D communication of the UE2 at f2u and the UE2 knows a data transmission region for D2D communication of the UE1 at f1u, it is possible to receive data for D2D communication transmitted by the peer UE.

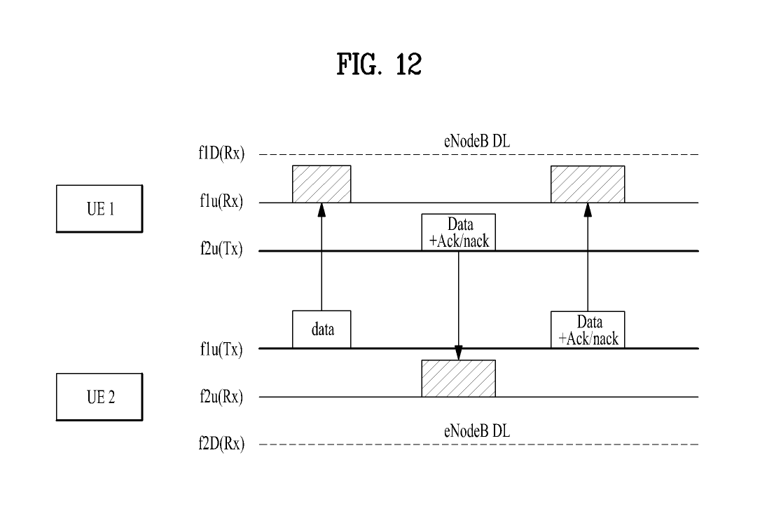

FIG. 12 is a diagram showing an example of operating frequency switching for D2D communication according to one embodiment of the present invention. According to the payment policy of a communication operator, the UE may be allowed to transmit data using a frequency of another communication operator (that is, a operator to which the peer UE subscribes). At this time, the payment policy applied when the UE subscribing to another operator uses the operator frequency is pre-negotiated between operators.

In this case, when the UE which will transmit data for D2D communication detects a peer UE operating at another operator frequency, the UE may switch the operating frequency that to the operator frequency of the peer UE and transmit data at the switched frequency. The same is true when the UE, which has received data for D2D communication from the peer UE, wishes to transmit ACK/NAK in response to the received data or to transmit data for D2D communication to the peer UE. In contrast, the UE, which has recognized that data for D2D communication to be received is present, need not switch the frequency thereof and may receive data from the peer UE in the resource region allocated to reception for D2D communication.

More specifically, the operations of the UE and the eNodeB will now be described. When the eNodeB acquires information that the UE and the peer UE detect each other, the eNodeB allocates resources for D2D communication, that is, a D2D period, to the UE and the peer UE. The D2D period may include information on a frequency switching time which may occur according to different transmission/reception frequency bands. When the UE, which will transmit data, acquires the D2D period from the eNodeB, the UE switches the operating frequency thereof to the operating frequency of the peer UE and then directly transmits data to the peer UE via the link. Information on the ID and operating frequency of the peer UE may be pre-acquired via the eNodeB and may be delivered in the D2D period as supplementary means. Information on the D2D period may include control information of the data transmission/reception time. At this time, the UE may transmit data to the peer UE at a transmission time (period) and return to the operator frequency thereof and receive data and ACK/NAK from the peer UE at a reception time (period).

When the UE, which has recognized that a peer UE which wishes to transmit data is present, acquires information on the D2D period from the eNodeB, the data is received from the peer UE at the reception time (period) of the D2D period. When the data is successfully received at the reception time, the UE may switch the frequency thereof to the operator frequency of the peer UE, transmit ACK and data to the peer UE. When the data is not received at the reception time, the UE may switch the frequency thereof to the operator frequency of the peer UE at the transmission time and then transmit ACK or wait for a next reception time.

In FIG. 11, the UEs perform the transmission operation at the operator frequency thereof and perform the reception operation at the operator frequency of the UE. In contrast, in FIG. 12, the UEs perform the reception operation of the operator frequency thereof and perform the transmission operation at the operator frequency of the peer UE.

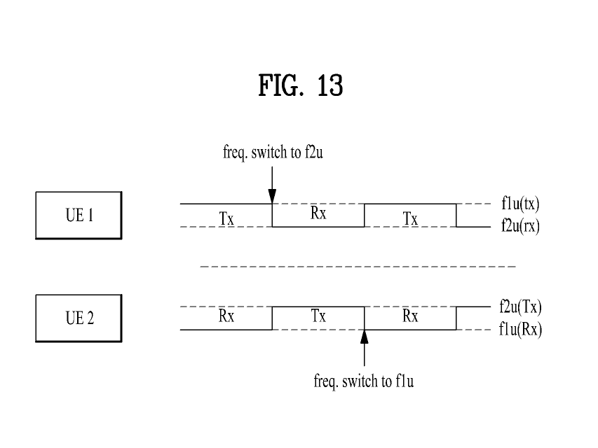

FIG. 13 is a diagram showing an example of synchronization in a D2D period according to one embodiment of the present invention. FIG. 13 shows setting of a D2D period when the frequency of the transmission operation and the frequency of the reception operation are different as in the embodiments shown in FIGS. 11 to 12. The UE1 and UE2 transmit data using a D2D communication method. When the frequency of the transmission operation and the frequency of the reception operation are different, the UE2 should be set to perform the reception operation in the period in which the UE 1 performs the transmission operation. This may be configured by the eNodeB in a D2D setup process. The UE1 may transmit data to the UE2 in an uplink frequency region f1u of the eNodeB1 and the UE2 may receive data from the UE1 in an uplink frequency region f1u of the eNodeB1. When the transmission operation period of the UE1 is finished, the UE1 may switch the operating frequency thereof to the uplink frequency f2u of the UE2 and perform the reception operation in this period. Such an operating frequency or transmission/reception operation mode switching time is referred to as a switching time.

In addition, the UE1 (or the UE2) may dynamically determine the frequency switching time. For example, there is a method for, at the UE1, transmitting data at the operating frequency of the UE2 which is the peer UE and subsequently transmitting a channel switching request. The UE1 may return to the operating frequency thereof after transmitting the channel switching request and the UE, which has received the channel switching request, may switch the frequency thereof to the operating frequency of the UE1.

The transmission/reception time of each UE shown in FIG. 13 may be predefined by negotiation between eNodeBs. For example, when the eNodeB1 determines and delivers the transmission time of the UE1 to the eNodeB2, the eNodeB2 may set the transmission time as the reception time thereof and determine and transmit an appropriate time corresponding to the transmission time of the UE1 as the transmission time of the UE2 to the eNodeB1. Here, the appropriate time is in a range within which latency is not excessively long while ensuring a minimum time necessary to decode ACK/NACK. At this time, the range may be predefined or predetermined by negotiation between eNodeBs. As the negotiated transmission time (or reception time) information, the UEs may be informed of the D2D transmission and reception period values in the D2D setup process.

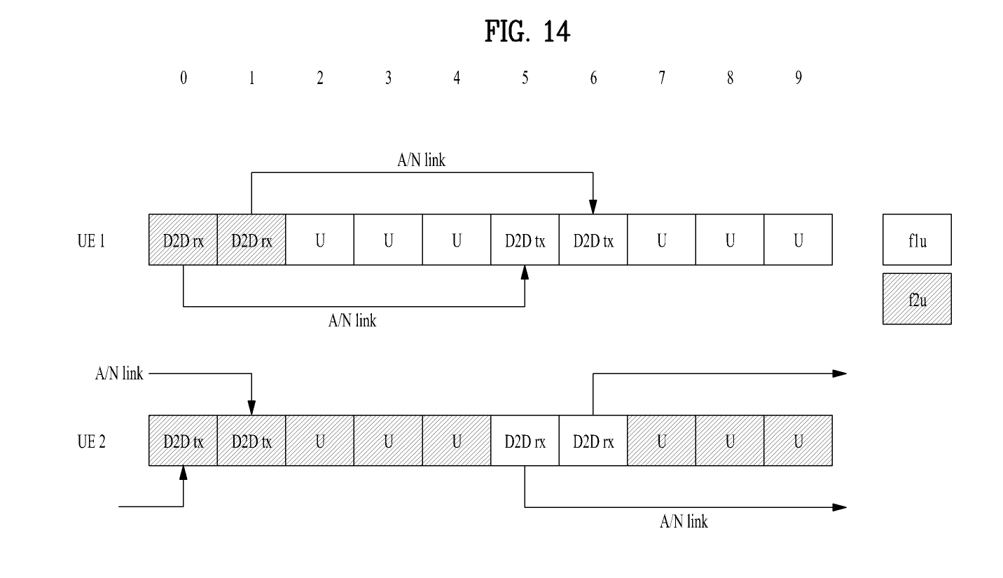

A simple example of determining the D2D transmission/reception time via negotiation between eNodeBs is shown in FIG. 14. The eNodeB1 may set subframes (SFs) #10n+5 as the D2D transmission time at an uplink frequency band f1u of the UE1 (n>=0). When the set transmission time is delivered to the eNodeB, the eNodeB2 may switch the time set as the transmission time of the UE1 in the uplink frequency band f1u of the UE1 and set the SFs corresponding thereto as the D2D reception time. Then, the eNodeB2 may select and set an appropriate time at the uplink frequency band f2u of the UE2 as the transmission time of the UE2 and then transmits a response to the eNodeB1. In FIG. 14, based on the UE1 at the frequency band f1u, the time corresponding to SF# 10n (n>=1) may be set to the transmission time of the UE2 by the eNodeB2.

When information on the transmission time of the UE2 is received from the eNodeB2, the eNodeB1 may switch and set the time as the D2D reception time at f2u. At this time, since symbol synchronization at each operator frequency may differ, a symbol difference and timing advance between the transmission UE and the reception UE are considered, both of which are not shown in FIG. 14 for convenience of description.

A transmission SF location set by the eNodeB2 in correspondence with the transmission time set by the eNodeB1 may be determined after predetermined m SFs from the transmission time set by the eNodeB1 (in FIG. 10, m=5). In this case, the transmission/reception times of all eNodeBs are determined by setting the transmission time of the eNodeB1 and the eNodeB may not transmit a response. For synchronization between D2D UEs, synchronization information of a radio frame/subframe between eNodeBs and timing advance information of each UE should be exchanged. This information may be delivered when information on the transmission time (or the reception time) is exchanged between eNodeBs or may be delivered or pre-exchanged via a separate message.

As described above, information on a D2D resource region delivered from the eNodeB to the UE may be delivered via RRC signaling or a control channel. When the information is delivered via RRC signaling, if one transmission (reception) time is determined and then the other reception (transmission) time is determined according to a predetermined rule, only the transmission resource region and period may be delivered as in the above-described D2D period. In contrast, if the transmission/reception time does not follow a specific rule but may be changed by decision of the eNodeB, a 1-bit indicator for distinguishing between the transmission and reception modes may be added to the D2D period to determine whether the resource region is allocated to transmission or reception. When resource allocation is performed via the control channel, different control message formats/identifiers (RNTIs) may be used.

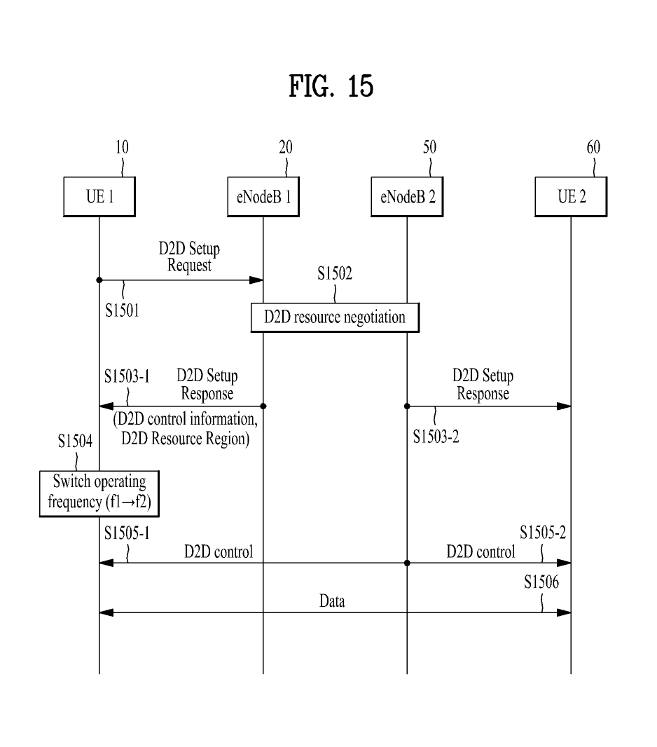

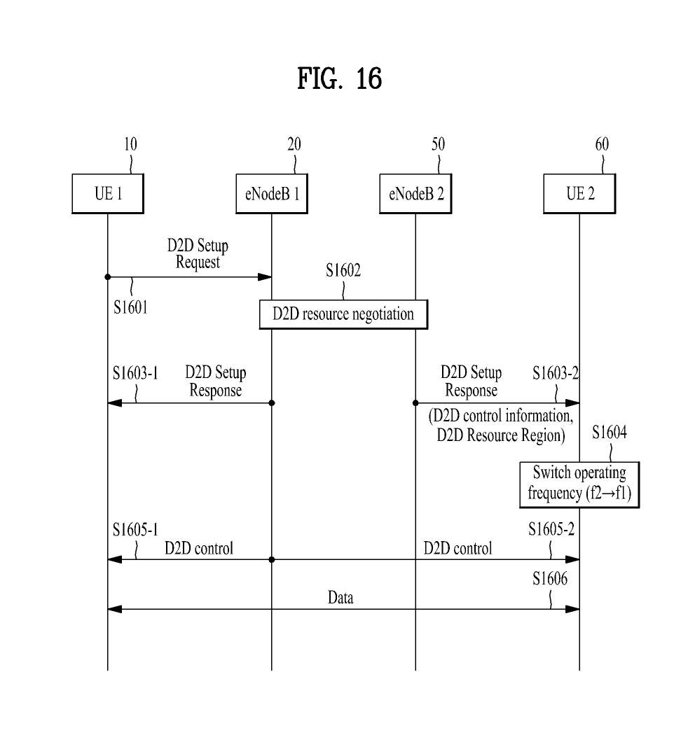

FIGS. 15 and 16 are diagrams showing a D2D setup and communication procedure according to one embodiment of the present invention. FIG. 15 is similar to the procedure of FIG. 7. Unlike FIG. 7, the D2D setup response message may be transmitted to the peer UE which does not transmit the D2D setup request message, that is, the UE2 60, and resource negotiation for D2D communication may be performed between eNodeBs before the D2D setup response message is transmitted. Repetition of the same description will be omitted.

When the D2D setup request message is received from the UE1 10 (S1501), the eNodeB1 20 may perform resource negotiation for D2D communication with the eNodeB of the UE2 20 which is the peer UE of the UE1 10, that is, the eNodeB2 50 (S1502). That is, the operator frequency to be used for D2D communication may be determined by resource negotiation between eNodeBs. At this time, UE capabilities, available D2D resource region, D2D load, etc. may be considered. For example, in UE capabilities, if the UE1 may operate at f1 and f2 but the UE2 60 may operate at 12 only, the operator frequency 12 of the UE2 may be determined as the operating frequency for D2D communication in the negotiation process between eNodeBs. Even in the available D2D resource region, if the operator of the UE2 60 does not separately allocate the resource region for D2D communication or resources allocable by the eNodeB2 50 for an additional D2D pair is relatively insufficient as compared to the resources of the eNodeB1 20, the operator frequency of the UE1 10 may be determined as the operating frequency for D2D communication.

The D2D setup response message may be delivered to both the UE1 10, which has transmitted the D2D setup request message, and the UE2 60 which is the peer UE (S1503-1 and S1503-2). At this time, information on the D2D period and the D2D resource region delivered to the UEs should coincide with each other. For coincidence of the resource region, as described above, a predetermined value may be used or a value determined by data exchange and resource negotiation between the eNodeBs may be used.

The D2D setup response message indicates the operator frequency to be used for D2D data communication. The UE, which has received the D2D setup response message, switches to the operator frequency and then receives a control channel at the operator frequency. If the same operator frequency equal to the operating frequency of the UE is used, the frequency is not switched and a resource region, in which a control channel for D2D communication is transmitted, is monitored to receive the control channel.

In the embodiment related to FIG. 15, since the operator frequency of the UE2 60 which is the peer UE of the UE1 10, which has transmitted the D2D setup request message, is used for D2D communication, the UE1 10 switches the operating frequency thereof to the operating frequency f2 of the UE2 60 (S1504) and the UE2 20 does not switch the operating frequency thereof. After frequency switching, the UE1 10 and the UE2 60 may receive the D2D control channel (or D2D PDCCH) from the second eNodeB 50 (S1505-1 and S1505-2) and perform D2D communication (S1506).

In the embodiment of FIG. 16, contrary to FIG. 15, the operator frequency of the UE1 10, which has transmitted the D2D setup request message, is used for D2D communication.

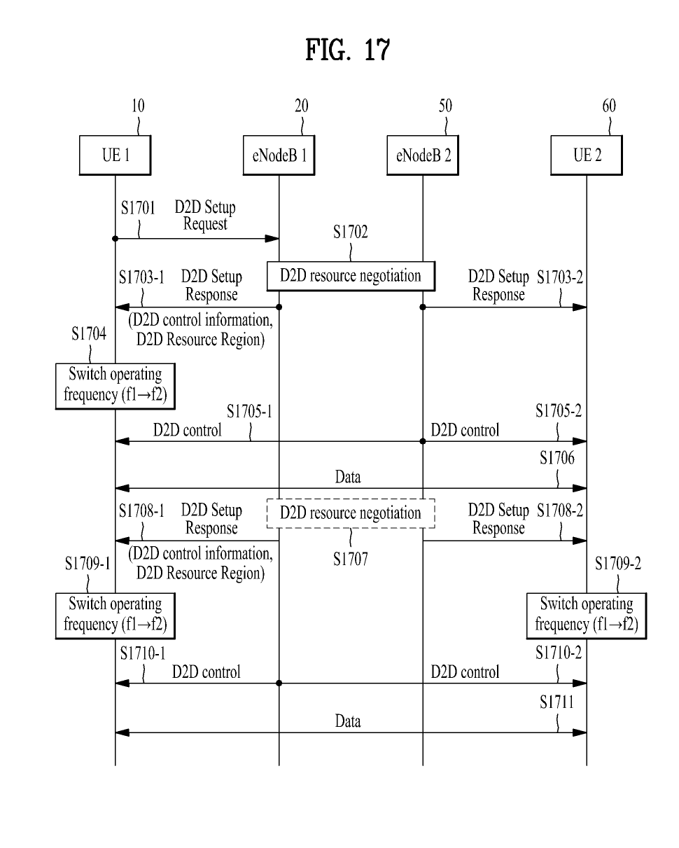

FIG. 17 is a diagram showing a resource renegotiation procedure for D2D setup, D2D communication and D2D communication between eNodeBs according to one embodiment of the present invention. Steps S1701 to S1706 of FIG. 17 are equal to steps S1501 to S1506 of FIG. 15 and a description thereof will be omitted.

The UEs, which have received the D2D setup response message, should monitor and receive the D2D control channel (or the D2D PDCCH) in order to perform data communication with the peer UE. In particular, the UE, which has switched the frequency thereof, may receive the control channel at the switched frequency. However, when the eNodeB notifies the UE of the transmission resource region for D2D communication via the D2D setup response message, it is possible to perform data transmission and reception in the region specified in the D2D setup response message without receiving the control channel after channel switching. That is, each UE receives the resource region information for D2D communication from each serving eNodeB. At this time, if the resource region information is for the operator frequency of the peer UE, the UE switches the operating frequency thereof to the operator frequency to perform D2D communication.

For example, when the operating frequency for D2D communication is determined, a resource region for D2D communication may be determined according to a predetermined rule or a resource region to be used may be specified in advance per operator frequency or eNodeB. However, even in this case, the operating frequency and the transmission and reception time of the UE may be renegotiated between eNodeBs.

In addition, when resources are dynamically allocated, the frequency is switched whenever the D2D resource region is changed and thus a signal related thereto should be received. That is, the UE which operates at the operator frequency of the peer UE should periodically switch the operating frequency thereof to the operator frequency in order to be allocated the D2D resource region. In contrast, since the UE includes a plurality of receivers, if each receiver may be used for D2D communication and communication with a serving eNodeB at the same time, the UE may not periodically switch the frequency thereof.

When the resource region for D2D communication is determined via renegotiation, each eNodeB transmits a D2D setup response message to the UE1 10 and the UE2 60 served thereby to notify the UEs of the information thereon. In the embodiment of FIG. 17, since the operating frequency for D2D communication is switched via renegotiation, each UE may switch the operating frequency thereof based on the operating frequency information included in the D2D setup response message (s1709-1 and S1709-2).

Before the D2D setup request process, the eNodeB may request D2D discovery from the UE pair. This is a process of at the UE, transmitting the signal to the peer UE via a radio channel so as to check that the UE is in a D2D communication range. For example, in FIG. 7, the eNodeB requests to transmit a predetermined discovery signal in a specific resource region from the UE and requests to scan the predetermined discovery signal in the same resource region from the peer UE. At this time, selection of the operator frequency and the resource region used to transmit the discovery signal may be determined in consideration of UE capabilities, available D2D resource region, D2D load, etc. via negotiation between the eNodeBs or the operators, similarly to determination of the D2D operating frequency and the resource region in the D2D setup process.

For example, if the eNodeB reserves predetermined resources to be used for a discovery signal in the cell of the UE1 but does not reserve predetermined resources to be used for the discovery signal in the cell of the UE2 because no D2D UE is present, the UE2 may move to the cell of the UE1 to perform a discovery procedure. However, information on transmission and reception should be delivered such that the UE, which has received the information, determines whether the discovery signal is transmitted or received and determines whether the operating frequency thereof is switched.

In addition, since resource negotiation is performed in the step of transmitting the discovery signal, the D2D setup response message may not include the operating operator frequency information in the D2D setup step. This is because the process of switching the frequency of the UE to use the same operator frequency and then switching the frequency for data transmission may be wasteful. In particular, if the discovery process between UEs is first performed, the D2D setup request message may report the result of the discovery process to the eNodeB. Only when the UE successfully receives the discovery signal of the peer UE, the next D2D setup procedure may be performed.

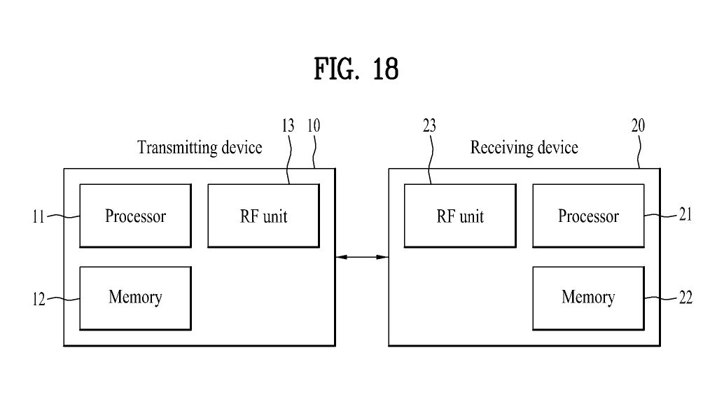

FIG. 18 is a block diagram of a device performing operation related to D2D communication according to exemplary embodiments of the present invention. The transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers.

The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

Specific configuration of the UE or the eNB functioning the transmitting device and/or the receiving device may be configured as a combination of one or more embodiments of the present invention.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

### INDUSTRIAL APPLICABILITY

The present invention is applicable to a wireless communication device such as a UE, a relay, an eNB, etc.

1. A method for, at a first user equipment (UE), performing device-to-device (D2D) communication with a second UE in a wireless communication system, the method comprising:
receiving a D2D communication setup response message including resource region information for D2D communication from a base station;
determining whether or not to switch an operating frequency band of the first UE from a first frequency band to a second frequency band based on the resource region information; and
performing the D2D communication with the second UE in the first frequency band or the second frequency band according to the result of determination,
wherein one of the first frequency band or the second frequency band is used for transmission for the D2D communication and another is used for reception for the D2D communication.

2. The method according to claim 1, wherein the transmission for the D2D communication is performed in the first frequency band and the reception for the D2D communication is performed in the second frequency band.

3. The method according to claim 1, wherein the transmission for the D2D communication is performed in the second frequency band and the reception for the D2D communication is performed in the first frequency band.

4. The method according to claim 1, wherein the resource region information includes information on a period for the D2D communication and a frequency for the D2D communication.

5. The method according to claim 1, wherein the operating frequency band is switched at a time when switching between the transmission and the reception for the D2D communication is occurred by the first UE or the second UE, and the time is indicated by information on a period for the D2D communication included in the resource region information.

6. The method according to claim 1, further comprising switching the operating frequency band to the second frequency band indicated by the resource region information.

7. The method according to claim 1, wherein the performing the D2D communication further includes monitoring a control channel for the D2D communication and receiving reception control information or transmission control information.

8. The method according to claim 1, wherein the D2D communication setup response message further includes information on a search space and a scrambling identifier of a control channel for the D2D communication.

9. A user equipment (UE) configured for perform device-to-device (D2D) communication with a peer UE in a wireless communication system, the UE comprising:
a radio frequency (RF) unit configured to transmit or receive an RF signal; and
a processor configured to control the RF unit,
wherein the processor is configured to receive a D2D communication setup response message including resource region information for D2D communication from a base station via the RF unit, to determine whether or not to switch an operating frequency band of the UE from a first frequency band to a second frequency band based on the resource region information, and to perform the D2D communication with the peer UE in the first frequency band or the second frequency band according to the result of determination, and
wherein one of the first frequency band or the second frequency band is used for transmission for the D2D communication and another is used for reception for the D2D communication.

10. The UE according to claim 9, wherein the transmission for the D2D communication is performed in the first frequency band and the reception for the D2D communication is performed in the second frequency band.

11. The UE according to claim 9, wherein the transmission for the D2D communication is performed in the second frequency band and the reception for the D2D communication is performed in the first frequency band.

12. The UE according to claim 9, wherein the resource region information includes information on a period for the D2D communication and a frequency for the D2D communication.

13. The UE according to claim 9, wherein the operating frequency band is switched at a time when switching between the transmission and the reception for the D2D communication is occurred by the first UE or the second UE, and the time is indicated by information on a period for the D2D communication included in the resource region information.

14. The UE according to claim 9, wherein the operating frequency band is switched to the second frequency band indicated by the resource region information.

15. The UE according to claim 9, wherein the processor is configured to monitor a control channel for the D2D communication and receives reception control information or transmission control information.

16. The UE according to claim 9, wherein the D2D communication setup response message further includes information on a search space and a scrambling identifier of a control channel for the D2D communication.

17. A method for, at a base station, supporting device-to-device (D2D) communication between a first user equipment (UE) and a second UE in a wireless communication system, the method comprising:
transmitting a D2D communication setup response message including resource region information for D2D communication to the first UE or the second UE,
wherein the resource region information includes information on a first frequency band and a second frequency band corresponding to an operating frequency band for D2D communication,
wherein one of the first frequency band or the second frequency band is used for transmission for the D2D communication and another is used for reception for the D2D communication.

18. A base station configured to support device-to-device (D2D) communication between a first user equipment (UE) and a second UE in a wireless communication system, the base station comprising:
a radio frequency (RF) unit configured to transmit or receive an RF signal; and
a processor configured to control the RF unit,
wherein the processor is configured to transmit a D2D communication setup response message including resource region information for D2D communication to the first UE or the second UE via the RF unit,
wherein the resource region information includes information on a first frequency band and a second frequency band corresponding to an operating frequency band for the D2D communication, and
wherein one of the first frequency band or the second frequency band is used for transmission for the D2D communication and another is used for reception for the D2D communication.
